(19) United States
(12) Patent Application Publication
(10) Pub. No.: US 2003/0195819 A1
(43) Pub. Date: Oct. 16, 2003

(54) Moving value chain system and its method

(76) Inventors: Kuo-Rong Chen, Panchiao City (TW); Chun-Chung Lee, Taipei (TW); Cheng-Hung Huang, Miaoli Hsien (TW)

Correspondence Address: BACON & THOMAS, PLLC, 625 SLATERS LANE, FOURTH FLOOR, ALEXANDRIA, VA, 22314

(21) Appl. No.: 10/180,293

(22) Filed: Jun. 27, 2002

(30) Foreign Application Priority Data
Apr. 16, 2002 (TW) 91108150

(51) Int. Cl. G06F 17/60

(52) U.S. Cl. 705/26

(57) ABSTRACT

A moving value chain system is disclosed, which uses a remote ordering apparatus to order merchandise and/or service from a customer service center server wirelessly, which customer service center server in turn transmits the order data from the remote ordering apparatus to a contracted store through a network system, enabling the contracted store to provide merchandise and/or service subject to the order data. The system further includes an issuing bank, which provides an approval code to the customer service center server after verified the credit status of the credit card number corresponding to an addressed communication access number received from the customer service center server, enabling the user to use the credit card to order merchandise and to complete the transaction wirelessly on the real time.

### BACKGROUND OF THE INVENTION

1. Field of the Invention

The present invention relates to a MVC (moving value chain) system and, more particularly, to such a MVC system, which enables the user to order merchandise and/or services wirelessly when moving and to complete the transaction by a credit card wirelessly on the real time. The invention relates also to a transaction method made through the MVC system.

2. Description of Related Art

The on-board system of a motor vehicle is generally equipped with a GSM (Global System for Mobile) wireless telephone system for enabling the driver to communicate with friends, or to dial up a service center requesting for a variety of information services, for example, stock price, weather report, traffic condition report, news, department store promotional merchandise, astrology, and etc. Further, a motor vehicle may be equipped with a GPS (Global Positioning System) that provides the information of the current location of the motor vehicle and business service information of nearby stores, or enables the driver to search for business service information about hotels and stores in the scheduled destination (for example, the information of locations of hotels, restaurants, theaters, landscape points), so that the driver can obtain the latest news and required information when driving the motor vehicle.

However, in the aforesaid known systems, the driver can only obtain business information from the service center when dialed up the service center, i.e., the driver cannot order attracted merchandise and/or services on the real time when driving the motor vehicle. If the driver requested for a reservation by voice through a GSM wireless telephone system on particular merchandise or requested a service center to make a reservation, he (she) cannot pay the money on the real time during driving. In this case, the transaction is not completely done, and the reserved merchandise or service may be sold out due to overdue or other reasons before the driver arriving the store.

Therefore, it is desirable to provide a MVC system that eliminates the aforesaid drawbacks.

### SUMMARY OF THE INVENTION

The present invention has been accomplished under the circumstances in view. It is therefore the main object of the present invention to provide a MVC (moving value chain) system, which enables the user to order merchandise and/or services when moving. It is another object of the present invention to provide a MVC system, which enables the user to complete the transaction by a credit card wirelessly when moving on the real time.

To achieve these and other objects of the present invention, the MVC system comprises at least one remote ordering apparatus, a credit card network system, and a customer service center server. Each remote ordering apparatus comprises an input device and a wireless communication apparatus. The input device is adapted for inputting an order data. The order data contains the item and quantity of the merchandise and/or service to be ordered. The wireless communication apparatus defines an addressed communication access number and is capable of sending out the addressed communication access number and the order data wirelessly. The credit card network system has linked thereto an issuing bank and a number of contracted stores. The issuing bank comprises an access number database and a credit database. The access number database has stored therein at least one addressed communication access number and a corresponding credit card number. The credit database has stored therein the credit status of the credit card number. The customer service center server is linked to the credit card network system, and adapted to receive wireless log-in connection from the wireless communication apparatus of each remote ordering apparatus, to receive and verify the addressed communication access number from the wireless communication apparatus of each remote ordering apparatus and the order data and then to transmit the addressed communication access number to the issuing bank through the credit card network system, for enabling the issuing bank to search the corresponding credit card number from the access number database subject to the addressed communication access number and to check the credit status of the corresponding credit card number stored in the credit database, so that the issuing bank can provide an approval code to the customer service center server to request the contracted stores to provide the ordered merchandise and/or service.

Another aspect of the present invention is to provide a moving value chain transaction method for use in the aforesaid moving value chain system. The method comprises the steps of (A) accepting wireless log-in connection; (B) receiving and verifying addressed communication access number and order data; (C) transmitting the addressed communication access number to the issuing bank; (D) searching the corresponding credit card number from the access number database subject to the addressed communication access number received in step (B), verifying the credit status of the corresponding credit card number, and then sending back an approval code; and (E) providing merchandise and/or service to complete the transaction.

According to a second embodiment of the present invention, the moving value chain system comprises at least one remote ordering apparatus, a network system, and a customer service center server. Each remote ordering apparatus comprises an input device and a wireless communication apparatus. The input device is adapted for inputting an order data. The order data contains the item and quantity of the merchandise and/or service to be ordered. The wireless communication apparatus is adapted for sending out the order data wirelessly. The network system is linked to a number of contracted stores. The customer service center server is linked to the network system, and adapted to receive wireless log-in connection from the wireless communication apparatus of each remote ordering apparatus and the order data, and then to transmit the order data to the contracted stores through the network system, requesting the contracted stores to provide the ordered merchandise and/or service.

A moving value chain transaction method for use in the moving value chain system according to the second embodiment of the present invention comprises the steps of (A) accepting wireless log-in connection; (B) receiving order data wirelessly; (C) transmitting the order data to contracted stores; and (D) providing merchandise and/or service to complete the transaction.

Other objects, advantages, and novel features of the invention will become more apparent from the following detailed description when taken in conjunction with the accompanying drawings.

### BRIEF DESCRIPTION OF THE DRAWINGS

FIG. 1 is a system architecture block diagram of a first embodiment of the present invention.

FIG. 2 is a flow chart of the first embodiment of the present invention.

FIG. 3 illustrates the structure of the merchandise data provided by the IVR device according to the first embodiment of the present invention.

FIG. 4 illustrates the structure of the service data provided by the IVR device according to the first embodiment of the present invention.

FIG. 5 is a system architecture block diagram of a second embodiment of the present invention.

FIG. 6 is a flow chart of the second embodiment of the present invention.

### DETAILED DESCRIPTION OF THE PREFERRED EMBODIMENT

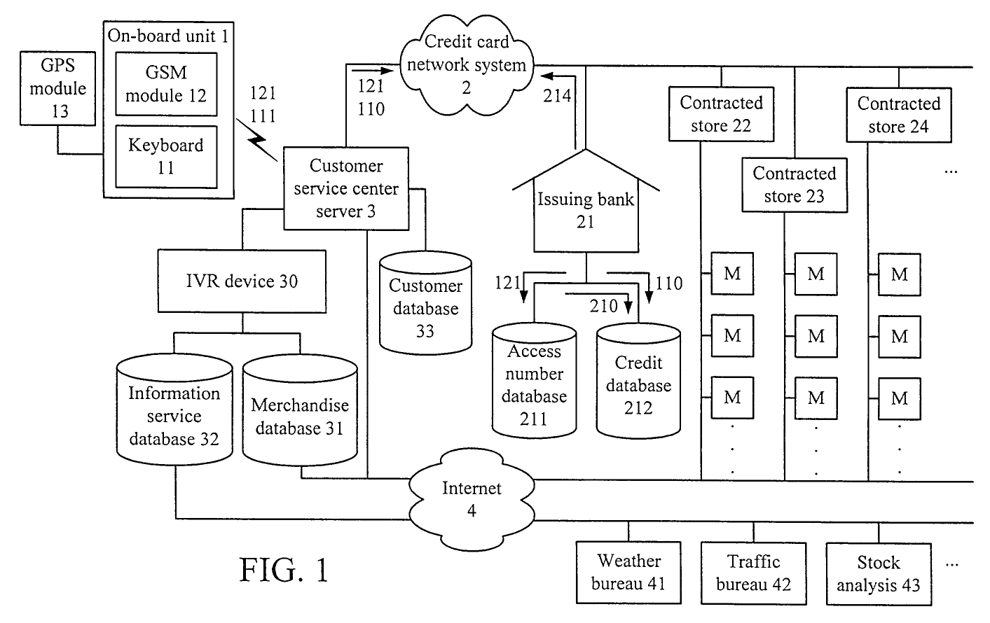

FIG. 1 is a flow chart of the first embodiment of the present invention. The present invention comprises an on-board unit 1 installed in a motor vehicle for use to order merchandise or services from the customer service center server 3. The on-board unit 1 comprises a GSM (Global System for Mobile) module 12 (wireless communication apparatus). The GSM module 12 comprises a keyboard 11 (input device), which enables the user to input the items of the merchandise and/or services to be ordered and the related quantity (order data 111), and a mobile telephone access number 121 (addressed communication access number). When the owner of the motor vehicle wishing to order merchandise or services from the customer service center server 3 through the on-board System 1, the on-board unit 1 will transmit the mobile telephone access number 121 and the order data 111 to the customer service center server 3 wirelessly.

When the customer service center server 3 received a wireless log-in signal from the on-board unit 1, it receives the mobile telephone access number 121 (caller ID) and the order data 111 at first, and then automatically calculates the total amount of transaction 110 subject to the order data 111, for example, the total amount of transaction 110 of ordering two bundles of flowers is US$30, and then transmits the mobile telephone access number 121 and the total amount of transaction 110 to the credit card network system 2. The order data 111 includes the item and quantity of tangible merchandise (theater/amusement center ticket, hotel reservation, restaurant reservation, and etc.) and/or intangible services (landscape introduction, on-line fortuneteller, multimedia audio/video program, repair and maintenance, . . . etc.) ordered.

As illustrated, the credit card network system 2 has linked thereto an issuing bank 21 and a number of contracted stores 22,23,24. The issuing bank 21 has an access number database 211 and a credit database 212. The access number database 211 has stored therein multiple mobile telephone access numbers 121 and multiple credit card numbers 210 corresponding to the mobile telephone access numbers 121. The credit database 212 has stored therein the individual credit status corresponding to the credit card numbers 210.

Therefore, when received the mobile telephone access number 121 and the total amount of transaction 110 from the customer service center server 3 through the credit card network system 2, the issuing bank 21 searches the access number database 211 for the corresponding credit card number 210 subject to the received mobile telephone access number 121, and then checks the credit card number 210 and the total amount of transaction 110 with the credit database 212 to see the credit status and the related credit limit of this credit card number 210. When authenticated, the issuing bank 21 sends back an approval code 214 to inform the customer service center server 3, for enabling the customer service center server 3 to provide the services lifted on the order data 111, or to inform the contracted stores 22,23,24 to provide merchandise M so as to complete the transaction.

It is to be noted that the mobile telephone access numbers 121 stored in the access number database 211 correspond to the credit numbers 210 preferably one to one so that all bills can be belonged to one individual credit card account. Of course, several mobile telephone access numbers 121 may correspond to one credit card number to belong the bills to a company credit card account. For example, the general manager, deputy general manager, or chief financial officer of a company may use different business motor vehicles of the computer to order merchandise or services from the customer service center server 3 for business. In this case, different mobile telephone access numbers of the mobile telephones equipped in the business motor vehicles of the computer may be corresponded to one single company credit card stored in the access number database 211. The mobile telephone access number of the wife's mobile telephone stored in the access number database 211 can also be corresponded to the husband's credit card number so that the bills of the wife can be added to the husband's account.

As illustrated in FIG. 1, the customer service center server 3 comprises an IVR (interactive voice response) device 30. The IVR device 30 automatically responds merchandise data stored in the merchandise database 31 and service data stored in the information service database 32 to the GSM module 12 of the on-board unit 1 by voice. The merchandise database 31 has stored therein information of tangible merchandise M provided by the contracted stores 22,23,24. The information of tangible merchandise M includes name of merchandise, item number, unit price, contracted store's address, telephone number, fax number, promotional information, way of delivery, way of collection, and etc. The information service database 32 has stored therein information of intangible services provided by weather bureau 41, traffic bureau 42, stock analysis 43, and other information providers.

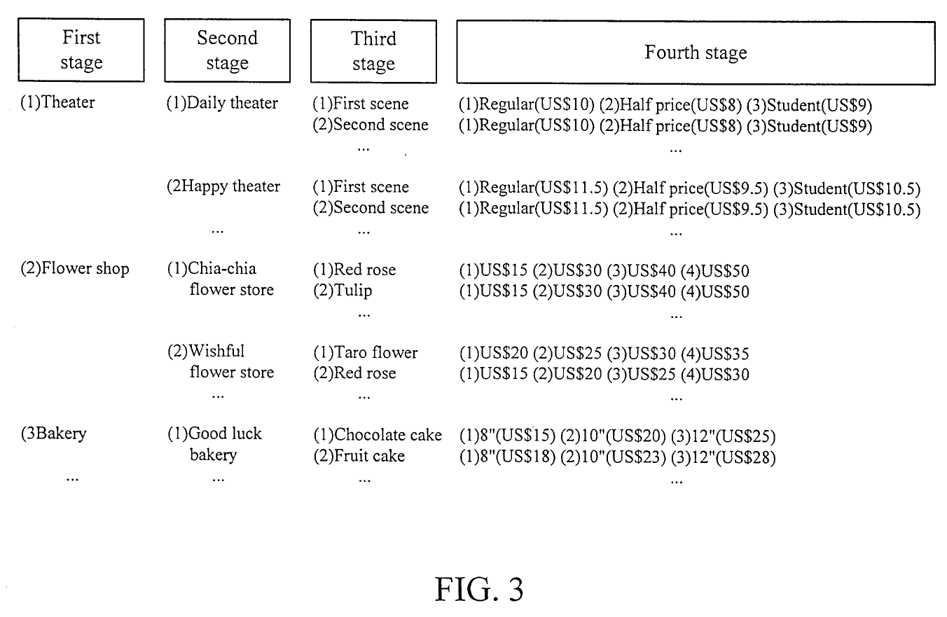

FIG. 3 is a schematic drawing showing the voice response architecture of the IVR device 30. Preferably, the voice response architecture is hierarchical. Of course, other prior art data architectures may be arranged. For example, when wishing to order a bundle of red roses @US$25 from Wishful flower store, the motor vehicle owner can then use the GSM module 12 to log in the customer serve center server 3. At this time, the customer service center server 3 fetches the merchandise information from the merchandise database 31, and then responds to the GSM module 12 by means of the IVR device 30. The IVR device 30 automatically produces a voice dialog subject to the architecture shown in FIG. 3.

Because the motor vehicle owner wishes to order a bundle of flowers, it is necessary to select the code “2” at the first stage so as to enter “flower store” menu, and then to click “2” on the keyboard 11 at the second stage subject to the instruction of the IVR device 30 so as to enter Wishful flower store, and then to click in proper order “2” red rose at the third stage and “2” US$20 at the fourth stage. If the motor vehicle owner already knew the code of the service desired, he (she) can directly input “2222” to order a bundle of red roses without listening to the IVR device 30. It is to be understood that the Daily theater, Happy theater, Chia-chia flower store, Wishful flower store, etc. are contracted stores registered in the customer service center server 3.

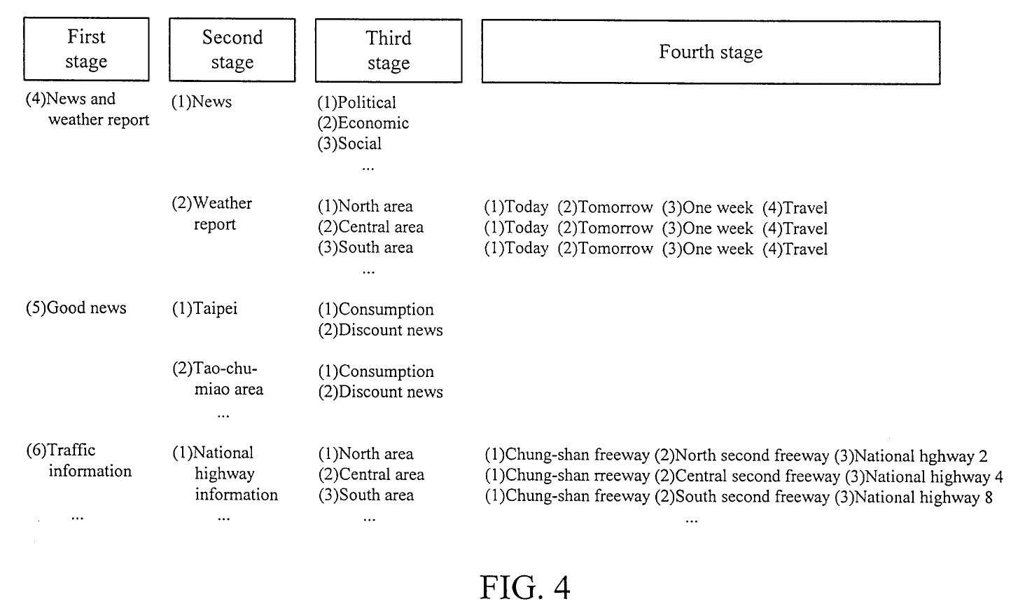

Similarly, in the information service architecture provided by the IVR device 30 as shown in FIG. 4, the motor vehicle owner can use the GSM module 12 to log in the customer service center server 3 when wishing to inquire the traffic conditions of Chung-shan freeway in the north area of the national highway system, and then click “6” at the first stage to enter “traffic information” menu, and then click in proper order “1” on the keyboard 11 at the second stage to enter national highway information, “1” north district at the third stage, and “1” Chung-shan freeway at the fourth stage. Alternatively, the motor vehicle owner can directly input “6111” to listen to traffic condition report service.

Further, through the Internet 4, the customer service center server 3 can be connected to the contracted stores 22,23,24 to automatically update the provided information of merchandise M, or connected to weather bureau 41, traffic bureau 42, stock analysis 43, and other information providers to update service data. Preferably, updating is achieved on the real time. Of course, updating can be achieved regularly, for example, once per every half hour.

In order to recognize the identify of the motor vehicle owner and to prevent the credit card number 210 corresponding to the mobile telephone access number 121 of the GSM module 12 to be used illegally by other people, a PIN verification system is performed i.e., the on-board unit 1 requests the user to input a code (for example, the PIN number of the mobile telephone or personal code set by the motor vehicle owner) through the keyboard 11 before ordering. When the correct code inputted, the on-board unit 1 transmits the mobile telephone access number 121 and the order data 111 to the customer service center server 3 wirelessly to run a credit card transaction. When wrong code number continuously inputted into the on-board unit 111 at the third time, the on-board unit 1 automatically locks the GSM module 12, rejecting wireless transmission. In this case, the motor vehicle owner must contact the customer service center server 3, requesting the customer service center server 3 to unlock the GSM module 12. Because the server 3 has a customer database 33 to store basic personal data and mobile telephone access number 121 of every client, the customer service center server 3 can run a security verification system, i.e., request the motor vehicle owner to provide his (her) basic personal data for verification with the corresponding basic personal data stored in the customer database 33 and then send an unlock command to the on-board unit 1 by means of a short message to unlock the GSM module 12 after the related data verified correctly.

Further, the customer service center server 3 can also lock the GSM module 12 imperatively. For example, when the motor vehicle owner has his (her) motor vehicle stolen, the motor vehicle owner can contact the customer service center server 3 to lock the right of using the GSM module 12. At this time, the customer service center server 3 checks the basic personal data of the motor vehicle owner subject to the aforesaid security verification system, and then dial to the GSM module 12 of the on-board unit 1 to send a lock command to the on-board unit 1 by means of a short message to lock the GSM module 12 after the related data verified, preventing others from using the motor vehicle owner's credit card to make a financial transaction illegally.

The aforesaid security verification system may include such a procedure that the customer service center server 3 transmits the mobile telephone access number 121 of the motor vehicle owner and the current total amount of transaction 110 to the issuing bank 21 through the credit card network system 2 only after the mobile telephone access number 121 received from the GSM module 12 has been checked with the customer basic personal data stored in the customer database 33 and verified correctly.

The security verification system of the customer service center server 3 hires persons in duty to compare the customer basic personal data stored in the customer database 33 manually. It can also compare the motor vehicle owner's personal data automatically by means of interactive voice response through a random sampling question and answer method, for example, asking the motor vehicle owner's name, ID card number, or residence telephone number, birthday, etc., i.e., interactive voice response asks different questions at different times so that the security verification system eliminates possible illegal use of the moving value chain system.

In FIG. 1, the on-board unit 1 further comprises a GPS module 13 adapted for providing the current location information of the motor vehicle. The GPS module 13 can also ensure the security of the transaction. For example, when the on-board unit 1 transacting business with the customer service center server 3, the on-board unit 1 simultaneously encodes the related information such as the current coordinate values (XY values) of the motor vehicle of the GPS module 13, the time data, the ID card number and the mobile telephone access number 121 of the motor vehicle owner, and the transaction serial number to obtain a checksum and then sends the checksum to the customer service center server 3 wirelessly. Upon receipt of the checksum, the customer service center server 3 decodes the checksum. This method enables the customer service center server 3 to trace the position of the motor vehicle during the transaction and, ensures the security of the wireless transmission.

Because the motor vehicle is equipped with the GPS module 13, the customer service center server 3 can provide the information of nearby contracted stores or data of nearby information providers subject to the position information provided by the GPS module 13 or information of nearby hotels and stores around the destination the motor vehicle owner is going to reach when the motor vehicle owner ordering a merchandise or service through the on-board unit 1. Therefore, the motor vehicle owner can obtain the latest news and required information, for example, the information of traffic conditions of the current location of the motor vehicle during moving of the motor vehicle. When the motor vehicle owner inputted the location information of the scheduled destination, the customer service center server 3 can provide the on-board unit 1 with navigation information and traffic conditions between the current location and the scheduled destination for enabling the motor vehicle owner to select the best route to the scheduled destination.

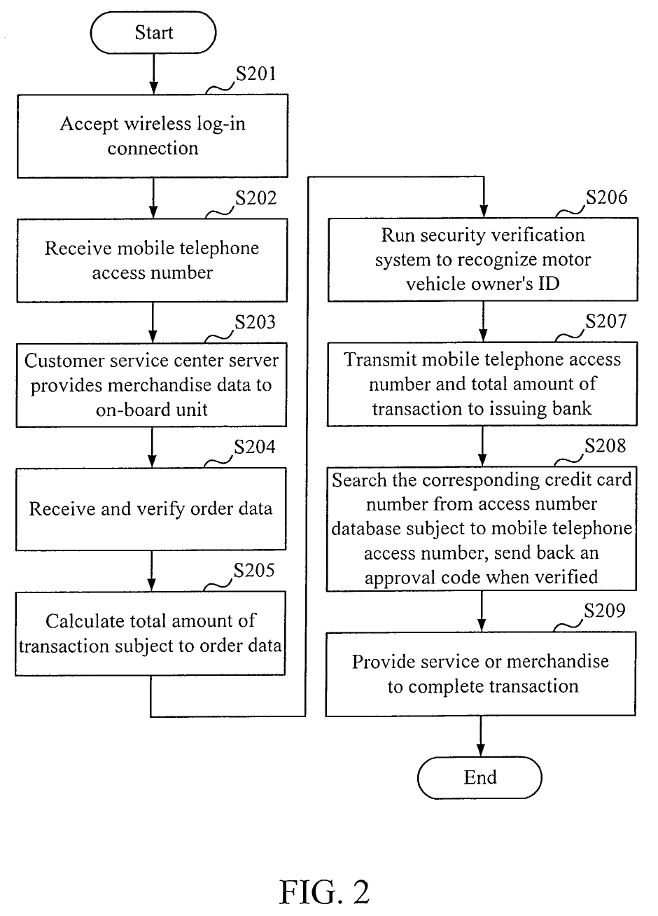

When the motor vehicle owner wishing to order merchandise or services from the customer service center server 3 under the transaction environment of the preferred embodiment of the present invention, the procedure is outlined hereinafter with reference to FIG. 2.

At first, the motor vehicle owner uses the GSM module 12 to dial up the customer service center server 3, requesting for merchandise or service data, and the customer service center server 3 accepts the wireless log-in connection of the GSM module 12 of the on-board unit 1 (step S201), and then accepts the mobile telephone access number 121 transmitted from the GSM module 12 (step S202). Thereafter, the customer service center server 3 provides merchandise data to the on-board unit 1 (step S203), for enabling the motor vehicle owner to select the desired merchandise or service. The customer service center server 3 provides merchandise and/or service data to the remote ordering apparatus wirelessly, for example, GSM modem, short message service, or digital broadcasting. Of course, the customer service center can issue compact disks or IC cards storing a variety of merchandise and service data regularly, and the on-board unit 1 is equipped with a CD-ROM player or card reader to read the content. The motor vehicle owner can input an order data 111 containing the ordered merchandise item number and quantity directly through the keyboard 11 of the on-board unit 1 and then send the order data 111 to the customer service center server 3 through the GSM module 12 so that the customer service center server 3 can receive and recognize the order data 111 transmitted from the GSM module 12 of the on-board unit 1 (step S204), and then calculate the total amount of transaction 110 (step S205).

Thereafter, the customer service center server 3 runs the security verification system to check the mobile telephone access number 121 transmitted from the GSM module 12 of the on-board unit 1 with the client's basic personal data stored in the customer database 33 so as to recognize the identification of the motor vehicle owner (step S206). When verified correctly, the customer service center server 3 sends the total amount of transaction 110 and the mobile telephone access number 121 to the issuing bank 21 through the credit card network system 2 (step S207), for enabling the issuing bank 21 to search the corresponding credit card number 210 from the access number database 211 subject to the mobile telephone access number 121 and then to transmit the total amount of transaction and the credit card number 210 to the credit database 212 for verifying the credit status and credit limit of the credit card number 210 and then to send an approval code 214 to the customer service center server 3 when verified (step S208). At this time, the customer service center server 3 can directly provide the service listed in the order data 111, or inform the contracted stores 22,23,24 to provide the merchandise M so as to complete the transaction (step S209). When the transaction finished, the customer service center server 3 sends a short message to the GSM module 12 of the on-board unit 1, informing the motor vehicle owner that the transaction has been finished.

Further, the motor vehicle owner can select the way of picking up the merchandise through the person in duty or the IVR device 30 during the transaction, for example, mailing the ordered ticket to the motor vehicle owner's residence; assigning to deliver the ordered bundle of flowers to a particular person at a particular location on Valentine's Day; informing the motor vehicle owner to the assigned location to pick up the merchandise (for example, the motor vehicle owner can directly go to the assigned convenience store, which entered an alliance with the customer service center, to pick up the ordered merchandise); or enabling the motor vehicle owner to go to the front counter of the hotel to check in when the reversed room of the hotel is in vacant.

The transaction environment of the present preferred embodiment is based on an on-board unit 1 in a motor vehicle for use as a remote ordering apparatus with a GSM module 12 as a wireless communication apparatus and a keyboard 11 as an input device. Under this environment, the addressed communication access number is the mobile telephone access number of the GSM module 12. The remote ordering apparatus can be installed in a PDA (personal digital assistant), airplane audio video system, a KIOSK (freestanding computer or terminal that provides information to the public through a multimedia display) in the airport or station, or any of a variety of equivalent moving apparatus. The wireless communication apparatus can be a GPRS module, satellite communication telephone, or the like that is capable of transmitting voice as well as data. The GPRS (general packet radio service) module can continuously receive merchandise and/or service data from the customer service center server 3 at any time by digital broadcasting. The address communication access number can be the E-mail address of a PDA, or a fixed address (TCP/IP in the Internet). The input device can be a quick-dial key, enter key, or touch panel.

In case the remote ordering apparatus is installed in an airplane audio video system in an airplane scheduled to fly to Tokyo Japan, the audio video system of the airplane can be connected to a customer service center server on the land through a satellite communication telephone or other wireless communication device of the airplane. In this case, the contracted stores of the customer service center server are hotels, restaurants, car rent companies, and landscape service centers in Tokyo; every passenger seat of the airplane has a respective addressed communication access number; the audio video system displays the merchandise or services provided by the contracted stores in Tokyo. Thus, passengers can request the airline company to register their credit card number and the addressed communication access number of the respective passenger seat before going aboard the airplane. Before arriving Tokyo, passengers can operate the touch panel of the airplane's video audio system to search and select the desired merchandise or service, and then to send the order data and the corresponding addressed communication access number to the server of the customer service center through the satellite communication telephone of the airplane wirelessly. The posterior transaction action will add the transaction account to the credit card number corresponding to the passenger seat addressed communication number. The other procedures are same as the aforesaid embodiment of the present invention.

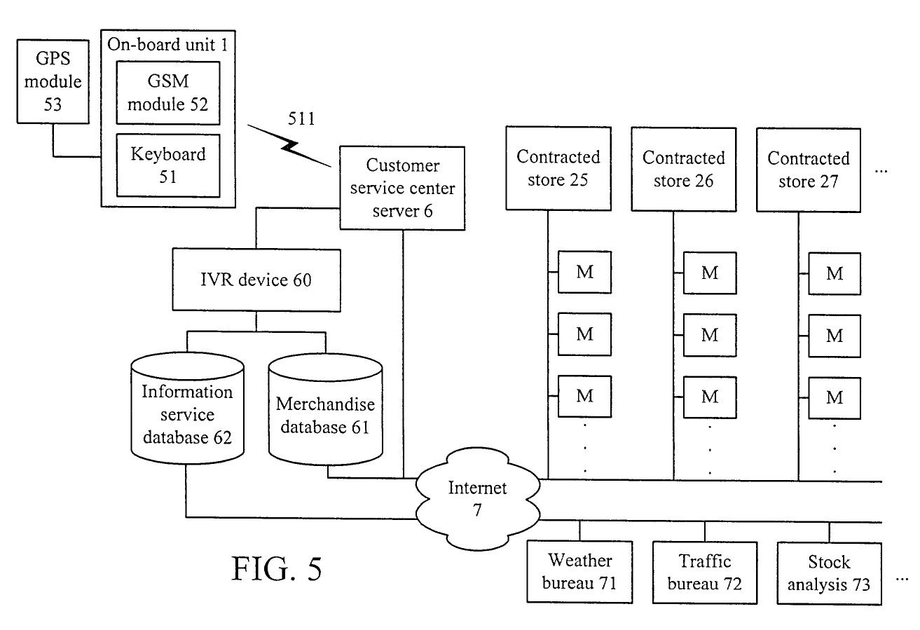

FIG. 5 shows the system architecture of a second embodiment of the present invention. According to this embodiment an on-board unit 5 is installed in a motor vehicle for use as a remote ordering apparatus for enabling the motor vehicle owner to order merchandise or service from a customer service center server 6. Similar to the aforesaid first embodiment of the present invention, the on-board unit 5 comprises a GSM module 52 and a keyboard 51 connected to the GSM module 52. When the motor vehicle owner wishing to order merchandise or service from the customer service center server 6 through the on-board unit 5, the on-board unit 5 transmits the order data 511 inputted by the motor vehicle owner through the keyboard 51 to the customer service center server 6 via the GSM module 52.

Because the customer service center server 6 is connectable to the contracted stores 25,26,27 through the Internet (network system) 7, the customer service center server 6 can transmit the order data 511 to the contracted stores 25,26,27 when received wireless log-in connection from the on-board unit 5, requesting the contracted stores 25,26,27 to provide merchandise so as to complete the transaction. Therefore, the customer service center server 6 can request the contracted stores 25,26,27 to pay the brokerage.

Further, the customer service center server 6 can be connected to weather bureau 71, traffic bureau 72, stock analysis 73, and other intangible service information providers through the Internet 7. Therefore, the customer service center server 6 can transmit received order data 511 to the information providers through the Internet 7, requesting the information providers to provide the ordered service and to complete the transaction. In case the service is simply to provide information (the information of weather or traffic conditions . . . ), the customer service center can charge the fee to the motor vehicle owner's account daily. If it is a value-added service (for example, stock analysis), the customer service center server 6 can directly switch to the contracted securities advisor and receive a brokerage from the contracted securities advisor.

As illustrated in FIG. 5, the customer service center server 6 can be directly connected to the contracted stores 25,26,27 through the Internet 7, or use an IVR (interactive voice response) device 60 to automatically respond the merchandise data stored in the merchandise database 61 and service data stored in the information service database 62 to the GSM module 52 of the on-board unit 5 automatically. The architectures of the IVR device 60, Merchandize Database 61 and information service database 62 of this embodiment are same as that shown in the aforesaid first embodiment of the present invention.

Further, the customer service center server 6 can be connected to the contrac6ted stores 25,26,27 through the Internet 7 to update the provided data of merchandise M automatically, or connected to the information providers to update the service data automatically. Preferably, updating is achieved on the real time. Of course, updating can be achieved regularly, for example, once per every half hour.

In FIG. 5, the on-board unit 1 further comprises a GPS module 53 adapted for providing the current location information of the motor vehicle. When the motor vehicle owner wishing to order merchandise or service from the customer service center server 6 through the on-board unit 5, the customer service center server 6 can provide the data of the contracted stores or information providers nearby the current location of the motor vehicle subject to the location information received from the GSP module 53 of the on-board unit 6, so that the motor vehicle owner can search nearby hotels and stores around the scheduled destination and obtain the latest news during moving of the motor vehicle.

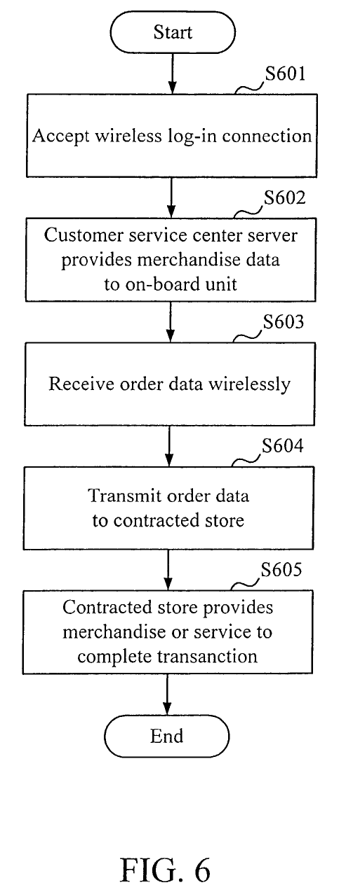

When the motor vehicle owner wishing to order merchandise or services from the customer service center server 6 under the transaction environment of this second embodiment of the present invention, the procedure is outlined hereinafter with reference to FIG. 6.

At first, the motor vehicle owner uses the GSM module 52 to dial up the customer service center server 6, requesting for merchandise or service data, and the customer service center server 6 accepts the wireless log-in connection of the GSM module 52 of the on-board unit 5 (step S601), thereafter the customer service center server 6 provides merchandise data to the on-board unit 5 (step S602), for enabling the motor vehicle owner to select the desired merchandise or service. The motor vehicle owner can use the keyboard 51 of the on-board unit 5 to input the merchandise or service to be ordered, forming an order data 511 containing the merchandise item and quantity, and then transmit the order data 511 to the customer service center server 6 through the GSM module 52 wirelessly. Therefore, the customer service center server 6 can receive the order data 511 from the GSM module 52 of the on-board unit 5 (step S603), and then transmit the order data 511 to the contracted stores 25,26,27 (step S604). At this time, the contracted stores 25,26,27 provide the ordered merchandise or service subject to the order data 511 to complete the transaction.

When the transaction done, the motor vehicle owner can select the way of payment, for example, going to the contracted stores 25,26,27 to pay the money by a credit card or by cash, or going to a post office to remit or transfer the payment. The motor vehicle owner can also select the way of picking up the merchandise, for example, going to the contracted stores 25,26,27 to pick up the merchandise, requesting to deliver the merchandise by mail, and etc.

The transaction environment of this second embodiment is based on an on-board unit 5 in a motor vehicle for use as a remote ordering apparatus with a GSM module 52 as a wireless communication apparatus and a keyboard 51 as an input device. Similar to the aforesaid first embodiment of the present invention, any of a variety of equivalent apparatus may be used as a substitute.

The invention can use a mobile communication apparatus to order merchandise or to request service information on the real time during movement, and can also use a credit card to complete the transaction wirelessly. By means of the wireless transaction environment provided by the present invention, the user can order merchandise conveniently during movement. Because the invention includes a remote ordering apparatus, a customer service center, an issuing bank, and contracted stores arranged in series, it is called “Moving Value Chain”.

Although the present invention has been explained in relation to its preferred embodiment, it is to be understood that many other possible modifications and variations can be made without departing from the spirit and scope of the invention as hereinafter claimed.

What is claimed is:

1. A moving value chain system comprising:
at least one remote ordering apparatus, each remote ordering apparatus comprising an input device and a wireless communication apparatus, said input device being adapted for inputting an order data, said order data containing the item and quantity of the merchandise and/or service to be ordered, said wireless communication apparatus defining an addressed communication access number and being capable of sending out said addressed communication access number and said order data wirelessly;
a credit card network system, said credit card network system having connected thereto an issuing bank and a number of contracted stores, said issuing bank comprising an access number database and a credit database, said access number database having stored therein at least one addressed communication access number and a corresponding credit card number, said credit database having stored therein the credit status of said credit card number; and
a customer service center server connected to said credit card network system, and adapted to receive wireless log-in connection from the wireless communication apparatus of each of said at least one remote ordering apparatus, to receive and verify the addressed communication access number from the wireless communication apparatus of each of said at least one remote ordering apparatus and said order data and then to transmit said addressed communication access number to said issuing bank through said credit card network system, for enabling said issuing bank to search the corresponding credit card number from said access number database subject to said addressed communication access number and to check the credit status of said corresponding credit card number stored in said credit database, so that said issuing bank can provide an approval code to said customer service center server to request said contracted stores to provide the ordered merchandise and/or service.

2. The moving value chain system as claimed in claim 1, wherein said at least one remote ordering apparatus each is installed in a motor vehicle.

3. The moving value chain system as claimed in claim 2, wherein said wireless communication apparatus is a mobile telephone; said addressed communication access number is the access number of said mobile telephone; said input device is the keyboard of said mobile telephone.

4. The moving value chain system as claimed in claim 1, wherein said remote ordering apparatus comprises a PIN verification system adapted to verify the personal identification number inputted through said input device and to allow said wireless communication apparatus to send out said order data when the personal identification number verified correctly.

5. The moving value chain system as claimed in claim 1, wherein said customer service center server comprises a merchandise database, said merchandise database having stored therein merchandise data provided by said contracted stores.

6. The moving value chain system as claimed in claim 5, wherein said customer service center server further comprises an interactive voice response device adapted to respond said merchandise data by voice automatically.

7. The moving value chain system as claimed in claim 5, wherein said customer service center server is connected to said contracted stores through the Internet to update said merchandise data.

8. The moving value chain system as claimed in claim 1, wherein said customer service center server further comprises an information service database, said information service database having stored therein service data provided by a plurality of information providers.

9. The moving value chain system as claimed in claim 8, wherein said customer service center server further comprises an interactive voice response device adapted to respond said service data by voice automatically.

10. The moving value chain system as claimed in claim 8, wherein said customer service center server is connected to said information providers through the Internet to update said service data.

11. The moving value chain system as claimed in claim 1, wherein said customer service center server further comprises a customer database and a security verification system, said customer database having stored therein basic personal data and individual addressed communication access number of clients, said security verification system being adapted to verify the addressed communication access number received from said wireless communication apparatus with the corresponding client's basic personal data stored in said customer database and then to allow said customer service center server to transmit said addressed communication access number to said issuing bank through said credit card network system when verified correctly.

12. The moving value chain system as claimed in claim 11, wherein said security verification system is to compare and check the corresponding client's basic personal data in said customer database manually.

13. The moving value chain system as claimed in claim 11, wherein said security verification system is to automatically compare and check the corresponding client's basic personal data by means of interactive voice response.

14. The moving value chain system as claimed in claim 13, wherein said interactive voice response runs through a random sampling question and answer method.

15. A moving value chain system comprising:
at least one remote ordering apparatus, said at least one remote ordering apparatus each comprising an input device and a wireless communication apparatus, said input device being adapted for inputting an order data, said order data containing the item and quantity of the merchandise and/or service to be ordered, said wireless communication apparatus being capable of sending out said order data wirelessly;
a network system linked to a number of contracted stores; and
a customer service center server linked to said network system and adapted to receive wireless log-in connection from the wireless communication apparatus of each of said at least one remote ordering apparatus and said order data, and then to transmit said order data to said contracted stores through said network system, requesting said contracted stores to provide the ordered merchandise and/or service.

16. The moving value chain system as claimed in claim 15, wherein said at least one remote ordering apparatus each further comprises a GPS (global positioning system) module adapted for providing the information of the current location of the respective remote ordering apparatus.

17. The moving value chain system as claimed in claim 15, wherein said customer service center server further comprises a merchandise database adapted for storing merchandise data provided by said contracted stores, and an information service database adapted for storing service data provided by a plurality of information providers.

18. The moving value chain system as claimed in claim 17, wherein said customer service center server further comprises an interactive voice response device adapted to respond said merchandise data and/or said service data by voice automatically.

19. The moving value chain system as claimed in claim 17, wherein said customer service center server is linked to said contracted stores and/or said information providers through the Internet to update said merchandise data and/or said service data.

20. The moving value chain system as claimed in claim 17, wherein said wireless communication apparatus is a GPRS mobile telephone adapted for receiving said merchandise data and/or said service data from said customer service center server by digital broadcasting.

21. A moving value chain transaction method used in a moving value chain system, said moving value chain system comprising at least one remote ordering apparatus, an issuing bank, and a customer service center server, said issuing bank comprising an access number database and a credit database, said access number database having stored therein at least one addressed communication access number and the corresponding credit card number, said credit database having stored therein the credit status of said credit card number, said at least one remote ordering apparatus each comprising an addressed communication access number and being capable of sending the addressed communication access number thereof and an order data to said customer service center server wirelessly, said order data defining the item and quantity of the merchandise and/or service to be ordered, the moving value chain transaction method comprising the steps of:
(A) accepting wireless log-in connection;
(B) receiving and verifying said addressed communication access number and order data;
(C) transmitting said addressed communication access number to said issuing bank;
(D) searching the corresponding credit card number from said access number database subject to said addressed communication access number received in said step (B), verifying the credit status of said corresponding credit card number, and then sending back an approval code; and
(E) providing merchandise and/or service to complete the transaction.

22. The moving value chain transaction method as claimed in claim 21, wherein said step (B) further comprises the sub-step of enabling said customer service center server to provide merchandise data and/or service data to said at least one remote ordering apparatus.

23. The moving value chain transaction method as claimed in claim 22, wherein said customer service center server provides merchandise data and/or service data to said at least one remote ordering apparatus by a wireless transmission method during said step (B).

24. The moving value chain transaction method as claimed in claim 21, wherein said customer service center server further comprises a customer database having stored therein basic personal data of clients; said step (C) further comprises a sub-step (C0) before said step (C) of comparing and checking the corresponding client's basic personal data in said customer database.

25. The moving value chain transaction method as claimed in claim 24, wherein said sub-step (C0) of comparing and checking the corresponding client's basic personal data in said customer database is achieved manually.

26. A moving value chain transaction method used in a moving value chain system, said moving value chain system comprising at least one remote ordering apparatus, a number of contracted stores, and a customer service center server, said at least one remote ordering apparatus being adapted for sending an order data to said customer service center server wirelessly, said order data defining the item and quantity of the merchandise and/or service to be ordered, the moving value chain transaction method comprising the steps of:
(A) accepting wireless log-in connection;
(B) receiving order data wirelessly;
(C) transmitting said order data to said contracted stores; and
(D) providing merchandise and/or service to complete the transaction.

27. The moving value chain transaction method as claimed in claim 26, wherein said step (B) further comprises the sub-step of enabling said customer service center server to provide merchandise data and/or service data to said at least one remote ordering apparatus wirelessly.
